(19) United States
(12) Patent Application Publication
(10) Pub. No.: US 2023/0236283 A1
(43) Pub. Date: Jul. 27, 2023

(54) Improved Method and System for Positioning

(71) Applicant: POZYX N.V., Gent (BE)

(72) Inventors: Jeroen Van Hecke, Gent (BE); Michiel Boes, Gent (BE); Samuel Van De Velde, Gent (BE)

(73) Assignee: POZYX N.V., Gent (BE)

(21) Appl. No.: 17/996,100

(22) PCT Filed: Apr. 14, 2020
(86) PCT No.: PCT/EP2020/060459

§ 371 Date: Oct. 13, 2022

(51) Int. Cl. G01S 5/12; G06K 19/077; H04W 4/029

(52) U.S. Cl. CPC G01S 5/12; G06K 19/07758; H04W 4/029

(57) ABSTRACT

The invention relates to a method for RTLS positioning of a tag with respect to a plurality of anchors, said plurality preferably comprising at least three anchors, wherein each of the anchors and the tag comprise wireless communication means for transmitting and receiving packets to and from the other ones of said plurality of anchors and said tag; said method comprising the steps of: for each respective of the anchors, controlling the tag and the respective anchor to perform two-way ranging, TWR, said TWR comprising at least the substeps of controlling one of the tag and the respective anchor to transmit one or more first measurement packets to the other one of the tag and the respective anchor, and controlling the other one of the tag and the respective anchor to, upon receipt of each respective of the first measurement packets, transmit a respective second measurement packet to the one of the tag and the respective anchor that transmitted the respective first measurement packet; calculating, by said tag or by any of said plurality of anchors or by a server connected to said plurality of anchors, the position of said tag.

### FIELD OF THE INVENTION

The present invention relates to real-time locating systems with wireless communication means. In embodiments, the wireless communication relates to UWB.

### BACKGROUND ART

In real-time locating systems, it is an aim to remotely determine the position and to track movement of objects, animals or people using wireless positioning and tracking systems in a wide range of applications. However, many known wireless positioning and tracking systems and methods suffer from limitations relating to accuracy, range, and robustness with respect to environmental interference. Particularly, prior art methods and systems lack accuracy and/or are overly complex.

WO2011123065A1 discloses a device for performing signal processing and a signal processing method for the localization of another device based on the difference of time of arrival of multiple signals using a single ultra wide band base station.

WO2017079839A1 discloses determining the position of a tag antenna relative to a plurality of spaced apart fixed base antennae using ultrawideband signals by using an angle of arrival determined by time of arrival of an ultrawideband signal from the tag antenna to disambiguate a differential phase angle of arrival measured from the differential phase of the ultrawideband signal between the two base antennae.

WO2019122080A1 discloses positioning involving a first base station and a second base station. The first base station is arranged to transmit a first signal to the second base station, and the second base station is arranged receive the first signal and transmit a second signal to the first base station in response to the first signal.

EP3226021A1 discloses a position determination method for determining the position of at least one movable object (tag) by sequential arrival time difference determination.

However, each of the methods and systems disclosed in WO2011123065A1, WO2017079839A1, WO2019122080A1 and EP3226021A1 either lack accuracy or are overly complex.

Accordingly, a method and related system for accurate positioning is desirable.

### SUMMARY OF THE INVENTION

It is an aim of the present invention to provide more accurate positioning.

It is a further aim of the invention to provide improved positioning while keeping positioning time low.

It is a further aim of the present invention to provide positioning that is more robust with respect to packet loss.

The invention provides, according to a first aspect, a method for RTLS positioning of a tag with respect to a plurality of anchors, said plurality preferably comprising at least three anchors, wherein each of the anchors and the tag comprise wireless communication means for transmitting and receiving packets to and from the other ones of said plurality of anchors and said tag; said method comprising the steps of:
for each respective of the anchors, controlling the tag and the respective anchor to perform two-way ranging, TWR, said TWR comprising at least the substeps of
   controlling one of the tag and the respective anchor to transmit one or more first measurement packets to the other one of the tag and the respective anchor, and
   controlling the other one of the tag and the respective anchor to, upon receipt of each respective of the first measurement packets, transmit a respective second measurement packet to the one of the tag and the respective anchor that transmitted the respective first measurement packet;
calculating, by said tag or by any of said plurality of anchors or by a server connected to said plurality of anchors, the position of said tag, said calculating comprising at least the substeps of:
   for each respective of the anchors, calculating a respective distance with respect to said tag based on at least one of the one or more first measurement packets and at least one of the one or more second measurement packets obtained for the respective anchor;
   calculating at least one time difference based on at least one further measurement packet,
      wherein, when said at least one time difference relates to time difference of arrival, TDOA, said at least one further measurement packet is transmitted between the tag and at least two of said plurality of anchors, and/or
      wherein, when said at least one time difference relates to reverse TDOA, said at least one further measurement packet comprises at least a respective first and second further measurement packet transmitted between the tag and respective ones of said plurality of anchors; and
   calculating, based on said respective distances and said at least one time difference, the position of said tag;
      wherein preferably at least one of said at least one further measurement packet is transmitted not later than at least one of said first and second measurement packets.

In embodiments, the number of anchors may be only two and still allow useful positioning based on calculating distance and time difference. One example is the case of 1D-movement of the tag, e.g., in a running event.

In embodiments, said calculating of the position is performed after TWR is completed, and/or, related, after expiry of some predetermined period for indicating that all measurement packets intended to be transmitted have been transmitted and/or have actually been received, which may, e.g., account for loss of one or more measurement packets due to noisy environments inherent to wireless channels.

In embodiments, the number of measurement packets transmitted per anchor and/or per tag may be chosen higher or lower and may be differentiated across anchors. In embodiments, said choosing of the number of measurement packets and/or said differentiation relates to meeting a pre-determined criterion to ensure that sufficient measurement data is available to calculate the position accurately. In embodiments, choosing of the number of measurement packets and/or said differentiation relates to choosing a number high enough to be resilient with respect to some level of packet loss. Thereby, embodiments wherein each of the anchors participates in TWR corresponds to examples whereby sufficient measurement data is available to ensure accurate position calculation even in the presence of some packet loss.

The present invention provides the advantages of improved accuracy as well as improved robustness and speed. In general, improved accuracy is obtained because the available positioning information is utilized more effectively. Overall, based on a combination of merely, e.g., a distance measurement, a time difference measurement and a third measurement, which may be any of a distance measurement or a time difference measurement, the invention may provide successful positioning. Furthermore, in examples relating to, e.g., 1D-movement over a predetermined path, it may be sufficient that at least one distance, relating to TWR, and at least one time difference, relating to TDOA and/or reverse TDOA, can effectively be calculated, to attain successful positioning. Additionally, in particular cases where, e.g., the tag happens to be outside the convex hull of the anchors, the invention allows to combine the accurate distance estimation provided by TWR with the accurate angle estimation of TDOA in those cases. Improved robustness is also provided, since TWR may compensate for the sensitivity of TDOA to anchor-anchor pair synchronization accuracy, while TDOA may compensate for the sensitivity of TWR with respect to common biases. Moreover, even where the conditions for TWR are not fulfilled, e.g., due to some packets being received but other ones being lost, positioning may still be performed based on the packets that were received. Also, a speed-up of positioning may be enabled when, e.g., one or more distances and/or one or more time differences may already be calculated while TWR is still ongoing. Additionally, since TWR may take up some time to complete, calculating time differences concurrently may allow enhanced speed of positioning and improved scalability, by providing time difference calculation “in parallel” for all anchors.

Furthermore, relying entirely on tag-anchor ranging and distances, as is the case in pure TWR, leads to larger vulnerability with respect to packet loss in noisy environments. By additionally calculating time differences, positioning may be accurate even if the ranging between each of the pairs is not completed. Rather, the present invention requires a less strict criterion to be met, wherein as long as a sufficient number of packets is transmitted, and most of the transmitted measurement packets are actually received by the tag and a sufficient number of anchors, the present invention provides successful positioning.

In a second aspect, which may be combined with the other aspects and embodiments described herein, the invention provides a system comprising
a plurality of anchors (1), said plurality preferably comprising at least three anchors;
a tag (2);
preferably, a server (3) connected to said plurality of anchors (1);

wherein each of said anchors (1) and said tag (2) comprise wireless communication means (11) for transmitting and receiving packets to and from the other ones of said plurality of anchors (1) and said tag (2);

wherein each of said anchors (1) and said tag (2) are configured for performing two-way ranging, TWR, said TWR comprising, for each respective of the anchors (1), at least the substeps of
controlling one of the tag (2) and the respective anchor (1) to transmit one or more first measurement packets (101) to the other one of the tag and the respective anchor, and
controlling the other one of the tag and the respective anchor to, upon receipt of each respective of the first measurement packets (101), transmit a respective second measurement packet (102) to the one of the tag and the respective anchor that transmitted the respective first measurement packet (101);

wherein any of said tag (2) or any of said plurality of anchors (1) or said server (3) is further configured for calculating a position of said tag (2), said calculating comprising at least the substeps of:
for each respective of the anchors (1), calculating a respective distance with respect to said tag (2) based on at least one of the one or more first measurement packets (101) and at least one of the one or more second measurement packets (102) obtained for the respective anchor (1);
calculating at least one time difference based on at least one further measurement packet,
   wherein, when said time difference relates to time difference of arrival, TDOA, said at least one further measurement packet is transmitted between the tag (2) and at least two of said plurality of anchors (1), and/or
   wherein, when said at least one time difference relates to reverse TDOA, said at least one further measurement packet comprises at least a respective first and second further measurement packet transmitted between the tag and respective ones of said plurality of anchors; and
calculating, based on said respective distances and said at least one time difference, the position of said tag (2);
   wherein at least one of said at least one further measurement packet is transmitted not later than at least one of said first and second measurement packets (101, 102).

In a third aspect, which may be combined with the other aspects and embodiments described herein, the invention provides a non-transient storage device, comprising computer-executable instructions which, when executed on a processor, cause the processor to perform the method of the invention.

Various embodiments and their advantages are described in the description and by the dependent claims.

### BRIEF DESCRIPTION OF THE DRAWINGS

The present invention will be discussed in more detail below, with reference to the attached drawings.

FIG. 1a and FIG. 1b show example embodiments of the present invention.

FIG. 2 illustrates an example configuration with four anchors and a tag.

FIGS. 3a and 3b show example GDOP patterns relating to TWR and TDOA, respectively.

FIG. 4 shows position error as a function of distance for an example configuration.

### DESCRIPTION OF EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice of the invention.

Furthermore, the terms first, second, third and the like in the description and in the claims, are used for distinguishing between similar elements and not necessarily for describing a sequential or chronological order. The terms are interchangeable under appropriate circumstances and the embodiments of the invention can operate in other sequences than described or illustrated herein.

Moreover, the terms top, bottom, over, under and the like in the description and the claims are used for descriptive purposes and not necessarily for describing relative positions. The terms so used are interchangeable under appropriate circumstances and the embodiments of the invention described herein can operate in other orientations than described or illustrated herein.

Furthermore, the various embodiments, although referred to as “preferred” are to be construed as exemplary manners in which the invention may be implemented rather than as limiting the scope of the invention.

The term “comprising”, used in the claims, should not be interpreted as being restricted to the elements or steps listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising A and B” should not be limited to devices consisting only of components A and B, rather with respect to the present invention, the only enumerated components of the device are A and B, and further the claim should be interpreted as including equivalents of those components.

In this document, the term “RTLS” refers to real-time locating system, a system to identify and/or track the location of objects or people in real-time.

In this document, the term “server” may refer to a local non-distributed machine comprising one or more processors, but may equally refer to a server system distributed over a plurality of remote locations, wherein, at each location, one or more machines belonging to the server system and each comprising one or more processors may be located. The server may be distinguished from the plurality of anchors or the tag but may also be integrated in one of them, or even be one of the anchors or the tag.

The plurality of anchors of the invention relate to anchors which may each be different from each other and from the one or more tags. In preferred embodiments, at least two of the anchors are interchangeable within the context of the invention; more preferably each of the anchors are interchangeable and/or each of the anchors and the one or more tags are interchangeable.

In the document, the term “tag” may refer to any device configured to receive and/or to transmit packets via a wireless interface. In embodiments, some or all of the one or more tags belong to the plurality of anchors. In embodiments, one or more or all of the tags do not belong to the plurality of anchors. Furthermore, in embodiments, the tag is not connected to the server and/or does not exchange data over the second connection means. In embodiments, one or more of the tags comprise a battery or equivalent energy source, e.g., a energy harvesting means. In embodiments, one or more of the tags are a completely wireless device operating on battery. In embodiments, one or more of the tag and the anchors are connected to the server via the second connection means.

In this document, 2D refers to an inherently two-dimensional configuration, such as a configuration where the anchors and one or more tags are assumed to be essentially or approximately coplanar. In real-world configurations, a third dimension is included, e.g., for accounting for 3D signal propagation, and/or because altitude is measured with an additional sensor. While the distinction between 2D, 2.5D and 3D may be useful for practical purposes such as convenience of graphical representation, the invention applies equally to any of these configurations.

In this document, GDOP refers to geometric dilution of precision.

In this document, the term “blink” refers to a measurement packet, typically a measurement packet that is transmitted intended as TDOA measurement. However, this does not exclude such blink packets to be used or reused for TWR measurement.

In this document, “reverse TDOA” refers to reverse-TDOA-based localization of a tag, wherein a tag is localized based at least in part on reception of a sufficient number of measurement packets by the tag. This is as opposed to “regular” TDOA, wherein a tag is localized based at least in part on receipt, by at least two anchors, of at least one measurement packet transmitted by the tag.

In embodiments, the wireless communication means may relate to any or any combination of Wi-Fi, 3G, 4G, 5G, HDSPA, LTE, RF, NFC, IEEE 802.11 a, b, g, n, ac, or ad, Bluetooth, WiMAX, ZigBee, or UWB. In preferred embodiments, the wireless communication means relates to UWB.

In embodiments, said at least one of said at least one further measurement packet being transmitted not later than at least one of said first and second measurement packets relates to said at least one of the at least one further measurement packet being one of the first or second measurement packets. This has the advantage of reducing the number of packets that need to be transmitted, reducing power consumption and interference, as well as leading to faster positioning.

In embodiments, said at least one of the at least one further measurement packet being one of the first or second measurement packets relates to
a further anchor of said plurality of anchors overhearing said one of the first or second measurement packets belonging to the TWR of the tag and an anchor different from said further anchor; and/or
a further tag different from said tag overhearing said one of the first or second measurement packets belonging to the TWR between the tag and one of the anchors.

This has the advantage of providing an effective reuse of packets, further enhancing the speed and efficiency of positioning.

In embodiments, all of the at least one further measurement packet are first or second measurement packets. This leads to a particularly effective implementation, wherein the calculation of time differences, relating to TDOA and/or reverse TDOA, on top of TWR, does not entail any overhead in signalling when compared to performing only TWR.

In embodiments, the method comprises the further step of:
controlling at least one of the plurality of anchors (1) and the tag (2) to transmit one or more third measurement packets different from said first and second measurement packets (101, 102);

wherein at least one of the at least one further measurement packet is one of the third measurement packets.

In such embodiments, the transmission of a third packet may relate to a simple “blink” for TDOA purposes, allowing to achieve the required number of measurements needed to perform accurate positioning. Such performing of a blink is much simpler than prior art methods involving only TWR, wherein a full TWR may be required to attain a desired accuracy.

In embodiments, the coordinates may relate to 2D coordinates, e.g., in the form (x,y), and the 2D position of a tag may be determined based on packet exchange with at least three anchors.

In embodiments, the coordinates may relate to 3D coordinates, e.g., in the form (x,y,z), and the 3D position of a tag may be determined based on packet exchange with at least four anchors.

In embodiments, said calculating of said position is performed at least in part by said tag, preferably is performed entirely by said tag, wherein said at least one time difference relates to reverse TDOA. This may provide the advantage of fast availability of a newly calculated position at the level of the tag.

In embodiments, said calculating of said position is performed at least in part by any of said plurality of anchors or by said server, preferably is performed entirely by said server, and wherein said at least one time difference relates to TDOA. This may be advantageous particularly in cases where the position of the tag is read out via an interface external to said tag and/or in cases where the tag is optimized with respect to cost or battery life.

In embodiments, the method comprises the further step of:
calculating, by at least one of the anchors, said tag or the server connected to said plurality of anchors, a clock rate and/or a clock offset of at least one of the anchors or the tag;
   wherein said calculating of said clock rate and/or said clock offset is based at least in part on one or more of the one or more first or second measurement packets or the at least one further measurement packet, preferably is based at least in part on one or more of the one or more first or second or third measurement packets or the at least one further measurement packet.

This has the advantage of minimizing the overhead related to clock synchronization, hence covering an important aspect of a RTLS. In related embodiments, first and second measurement packets used for TWR are additionally used for any or any combination of TDOA, reverse TDOA and clock synchronization.

In embodiments, the tag belongs to a plurality of tags comprising at least one further tag, said further tag comprising said wireless communication means for transmitting and receiving packets to and from the plurality of anchors and said tag; wherein a relative position among the plurality of anchors is fixed; wherein a relative position between the plurality of tags is fixed; and wherein said calculating of said position of said tag comprises calculating a single tag group position associated with the plurality of tags.

This has the advantage of enhanced flexibility, allowing to provide an accurate estimate of a single position while providing redundancy with respect to failures of a single tag. Also improved accuracy is provided, since the addition of tags leads to an increased number of measurements, hence allowing to better compensate for noise.

In embodiments with a further tag, the method comprises the further step of:
calculating, by any of said tag or said further tag or by any of the plurality of anchors or by the server connected to said plurality of anchors, a tag group orientation associated with the plurality of tags.

Such embodiments advantageously allow to take full use of the presence of more than one tag, by performing tracking of orientation in addition to tracking of position. When compared to a prior art method based on, e.g., sensors for detecting a change in orientation, this provides the advantage of using the existing hardware and software, and avoiding the incorporation of sensors.

In embodiments, the plurality of anchors and the tag, preferably the plurality of anchors and the plurality of tags, are configured as interchangeable devices, wherein the method comprises the further step of:
calculating a second position associated with one of the anchors acting according to a tag configuration; and/or
calculating said position or said second position based at least in part on said tag acting according to an anchor configuration.

This has the advantage of providing a versatile means, wherein any first group of electronic devices and second group of electronic devices can take up the role most suitable for a task at hand.

In embodiments, the method comprises the further steps of:
calculating a confidence value with respect to said calculated position being a non-final position;
comparing said confidence value with a predetermined value;
if said confidence value is below a predetermined value:
   controlling at least one of the plurality of anchors and the tag to transmit a fourth measurement packet, preferably one or more fourth measurement packets, different from said first and second measurement packets;
   calculating one or more second time differences relating to said TDOA and/or said reverse TDOA, based on at least said fourth measurement packet; and
   recalculating the position based on said one or more second time differences;
   assigning said recalculated position as a final position; else,
   assigning the non-final position as the final position.

This has the advantage of flexible management of accuracy, wherein incremental steps may lead toward a desired level of accuracy.

In embodiments, said performing of said TWR relates to any or any combination of: symmetric double-sided ranging, asymmetric double-sided ranging, fast ranging, mass ranging.

In embodiments with symmetric/asymmetric double-sided ranging, this may relate to exchanging 3 or 4 packets between tag and anchor. In embodiments with fast ranging, a packet exchange of 2 packets between tag and anchor may be required, wherein also some synchronization information is reused over multiple successive rangings. In embodiments with mass ranging, 1 anchor broadcasts a packet, and multiple tags reply to this packet, wherein each tag has its own fixed delay. This provides the effect that multiple rangings between different anchor-tag pairs get combined in a much shorter time frame.

In embodiments, said wireless communication means relates to UWB.

In embodiments, the anchors are connected to a server through second communication means. In embodiments, the second communication means is a cable connecting the anchors to the server according to a bus topology, preferably relating to Ethernet, wherein more preferably the second communication means relates to power of Ethernet for powering at least one of the anchors. This is advantageous as it provides a very reliable communication means with minimal risk of interference with the wireless communication means. Moreover, in embodiments with power over Ethernet, a single connection may provide each anchor with both power and second communication means. In alternative embodiments, the second communication means relates to a second wireless communication means, e.g., Wi-Fi, 3G, 4G, 5G, HDSPA, LTE, RF, NFC, IEEE 802.11a, b, g, n, ac, or ad, Bluetooth, WiMAX, ZigBee, or UWB, which may be applied for connecting at least one, or even all of the anchors, to the server. In such cases, interference between the first and second communication means may be prevented with interference prevention means known to the skilled person such as any or any combination of time division multiplexing, wavelength division multiplexing, code division multiplexing, etc.

In embodiments, at least one anchor comprises a means for detecting motion and/or dislocation, preferably one or more of an accelerometer, a gyroscope, a magnetometer, a pressure sensor, and/or an IMU. This is advantageous since it allows to deal with changes in the environment. Particularly, it enables to distinguish between anchor movement and temporarily blocked line-of-sight. This is particularly important for RTLS, where apart from tag movement also movement of anchors can be taken into consideration.

In embodiments, the system relates to a positioning system consisting of a group of N anchors and at least one tag. In embodiments, each anchor has its own dedicated clock, with an unknown drift and time offset. In embodiments, timestamps of the different anchors are mapped in a single time reference frame, facilitating the calculation of time differences for, e.g., TDOA and reverse TDOA purposes.

In embodiments, the system consists of a group of N anchors and M tags, wherein the anchors have a fixed and known position (x,y,z) and are synchronized, and the position of the tags is unknown and has to be estimated. For such embodiments, there are two main positioning mechanisms to achieve this: TDOA and TWR. Regarding TDOA, both regular TDOA and reverse TDOA may be considered; both variations require accurate synchronization between the anchors' clocks. The available measurements for these mechanisms may be time differences which are fed to the input of an estimator. For regular TDOA, the tag may broadcast a short message. Based on the difference of the arrival time on several anchors, one may estimate the tag's position. In order to use the time differences, the anchors may have to be accurately synchronized. For reverse TDOA, the tag need not transmit a message. The tag may receive messages from the anchors with their synchronized timestamps. From their time differences, together with the anchors' coordinates, the tag may then calculate its own position. Regarding TWR, the tag may range with several anchors. For each anchor, the distance between the anchor and tag may be estimated. This estimation, or ranging, may occur by transmitting several packets between tag and anchor. The available measurements for this protocol may be distances. These distances may be the input to an estimator, which may return the tag's position. In embodiments of the invention, TWR and TDOA are combined to achieve a higher positioning accuracy and update rate. The gathered time differences, together with the measured distances may be used as input for the positioning.

In embodiments, air time used to perform TWR measurements is used additionally to gather (regular and/or reverse) TDOA measurements.

In embodiments, a ranging takes place between an anchor and a tag is overheard by another anchor. For instance, two or more packets get exchanged between the ranging anchor and tag. This operation results in an estimated distance (TWR measurement) between both. However, each packet that gets transmitted from the tag may also be overheard by other anchors. By calculating the differences of these arrival times, also 1 or several TDOA measurements are put at disposal.

In embodiments, by using packets transmitted by the anchor, the tag may also use these as a reverse TDOA measurement. These packets can be part of a ranging sequence.

In embodiments, the tag may be controlled to transmit 1 or more additional blinks that provide the system with additional TDOA measurements.

In embodiments, one or more of the anchors are controlled to transmit one or more additional blinks that can be used by the tag as 1 or more reverse TDOA measurements.

In embodiments, the system may perform a) rangings between anchor and tag, b) may control the anchors to transmit 1 or more separate blinks and c) may control the tag to transmit 1 or more separate blinks. In such embodiments, rangings provide TWR measurements. The blinks of the anchor may be used by the tag as reverse TDOA measurements. Thereby, the blinks may or may not be part of a ranging procedure, i.e. a TWR. The blinks of the tag may be used by the anchors as TDOA measurement. Also here, the blinks may or may not be part of a ranging procedure, i.e. a TWR.

Further advantages of embodiments of the invention may be understood from the following:
An estimate of the positioning using TWR takes up more UWB air time, than a positioning estimate using TDOA. For TDOA only a single packet needs to be transmitted by the tag. For TWR, one may, e.g., require minimum 2 packets (possible under certain restrictions) between each tag-anchor pair for the distance is to be known. In embodiments, by combining TWR and TDOA one can reuse the packets that are used for TWR measurements as TDOA measurements. For each packet that the tag transmits (at least 1/range), one may capture the receive times for all the anchors that have received this packet. This may provide exactly the same information as a pure TDOA blink. For example: a tag that ranges with 4 anchors, provides at least 4 TDOA measurements. To summarize: 1 TWR positioning update may provide at least 1 TDOA positioning update/tag-anchor pair.
Increased flexibility between the trade-off in update rate, power, required accuracy. In embodiments, the system can choose anything on a scale ranging between full TWR and full (reverse) TDOA depending on the specific requirements and setup. Additional (reverse) TDOA blinks may be added to increase the amount of TDOA measurements compared to TWR measurements.
Timestamp measurements often have a certain bias. A part of this bias is common across all anchors. In embodiments, combining both types of measurements allows us to reduce the impact of the common biases (a main source of error in TWR) in the positioning accuracy, as the common part of the bias has no impact on the accuracy when using the TDOA protocol.
The invention provides an advantageous complementary role for TWR and TDOA. In general, the error that is present when synchronizing the anchors for TDOA, does not have any influence on the TWR measurements. For TWR, there is only some impact of synchronization errors between the tag-anchor pair, if any, but this error is of a lower order of magnitude than the synchronization error for TDOA.
Combining TWR and TDOA adds additional redundancy to the TWR mechanism. When 1 or more rangings (distance measurements) fail, the TWR protocol may fail to deliver a positioning estimate due to insufficient information. As other anchors overhear this information, additional measurements (time-differences) are available for free. This additional information can be enough to allow a successful positioning update. In embodiments, this additional redundancy is used to further refine the outlier selection as more measurements are available. In embodiments, the number of ranges is reduced when compared to the number that a TWR-only mechanism would require in order to estimate the tag's position.
In embodiments, the system is described as combination of anchors and tags, wherein the anchors are devices that have a fixed location relative to each other and are (wired or wireless) synchronized between themselves, and wherein the tags are devices that have an unknown position and are not synchronized between themselves. In embodiments, this distinction is not restrictive. In embodiments, the system comprises of devices belonging to two groups, wherein each group is synchronized between themselves and wherein each device in a group has a fixed location relative to each other device in that same group. This may make the complete setup extremely symmetric. In such embodiments, the unknown position may then be how these two (or even more) groups are positioned towards each other. In such embodiments, no distinction is made between tag and anchor, and each device may aid other devices in their positioning (act as an anchor), and may also be positioned relatively to another group (act as a tag). In embodiments wherein the group consists of more than 1 device, one may estimate not only the position but also the orientation this group.
In embodiments, blinks of an anchor can be used by the tag as reverse TDOA measurements. In embodiments, these same blinks can also be used by the anchors to aid in the anchor synchronization.
In embodiments, the anchors transmit synchronization packets and the tag responds to these messages with a fixed delay. This allows the anchors to capture time differences (TDOA) together with distances (TWR). This requires less air time than the standard ranging scheme+synchronization.

In the following, the invention will be illustrated by several examples, which are not intended to limit the invention in any way.

### Example 1

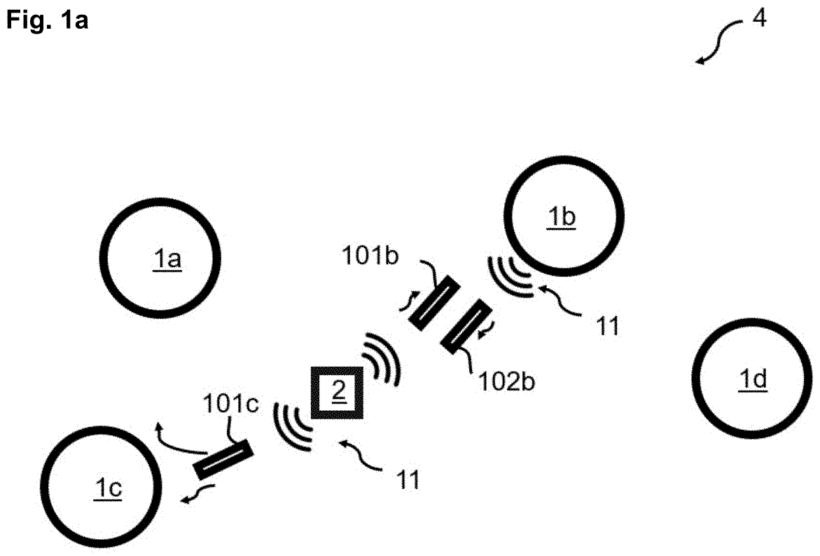

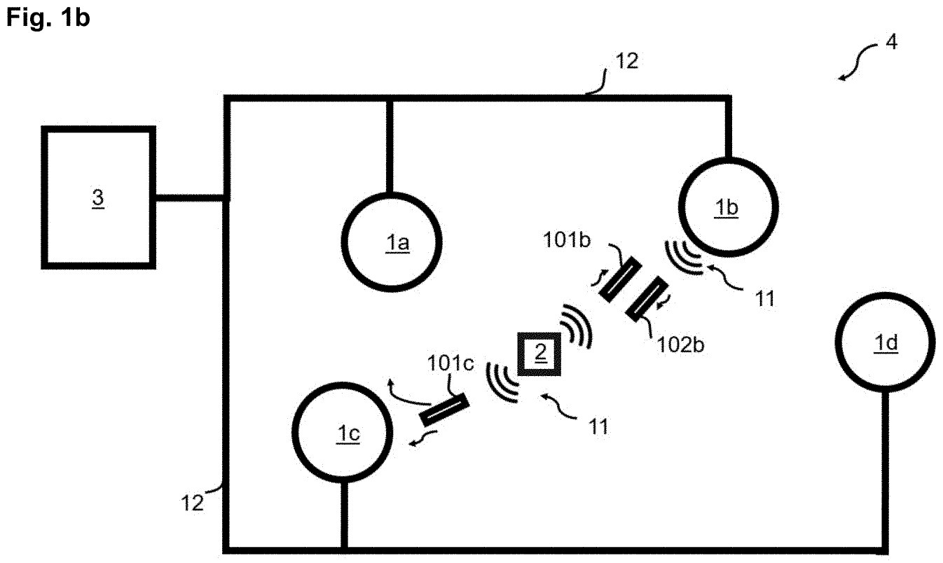

FIG. 1a and FIG. 1b show example embodiments of the present invention. Particularly FIG. 1 shows a system 4 comprising a tag 2 and four anchors 1a, 1b, 1c, 1d. Each anchor and the tag comprise wireless communication means 11 for transmitting and receiving packets to and from the other ones of said anchors 1 and said tag. In the example of FIG. 1b, the system 4 further comprises a server 3 and second communication means 12 for connecting to said server 3. In this example, the first communication means relates to UWB whereas the second communication means relates to a cabled Ethernet connection.

In each of FIGS. 1a and 1b, for each respective of the anchors 1a, 1b, 1c, 1d, the tag 2 and the respective anchor 1a, 1b, 1c, 1d are controlled to perform TWR. The TWR comprises controlling one of the tag 2 and the respective anchor 1a, 1b, 1c, 1d to transmit one or more first measurement packets 101b, 101c to the other one of the tag and the respective anchor. In this example, it is the tag 2 sending the first measurement packets, i.e. one first measurement packet 101b to anchor 1b, and another first measurement packet 101c to anchor 1c. In response, the respective anchor is controlled to, upon receipt of each respective of the first measurement packets 101b, 101c, transmit a respective second measurement packet 102b to the one of the tag and the respective anchor that transmitted the respective first measurement packet 101b. In this example, apart from communication not shown in the figures, anchor 1b has already acknowledged receipt of the first measurement packet 101b by transmitting second measurement packet 102b.

The position of the tag 2 is subsequently calculated. It comprises, for at least one of the anchors 1a, 1b, 1c, 1d, calculating a respective distance with respect to said tag 2 based on at least one of the one or more first measurement packets 101b, 101c and at least one of the one or more second measurement packets 102b obtained for the respective anchor. It also comprises calculating at least one time difference, said at least one time difference relating to time difference of arrival, TDOA, based on at least one further measurement packet transmitted between the tag 2 and at least two of said plurality of anchors 1, and/or reverse TDOA, based on at least a respective first and second further measurement packet transmitted between the tag 2 and respective ones of said plurality of anchors 1a, 1b, 1c, 1d. In this example, the first measurement packet 101c is received by anchor 1c as part of TWR measurement but is also overheard by anchor 1a. This type of overhearing and reusing of packets allows to gather measurements and is, in this example, sufficient to calculate a time difference between arrival of a first measurement packet 101c at anchor 1a and anchor 1c. Alternatively or additionally, a third measurement packet (not shown) may be transmitted by the tag, preferably while TWR is ongoing, wherein the third measurement packet is intended to contribute to TDOA measurement, as one of the at least one further measurement packet. The position of the tag is then calculated based on said respective distances and said at least one time difference.

The difference between FIGS. 1a and 1b relates to the presence of a server 3 in FIG. 1b. In FIG. 1a, without server, any of the tag of the anchors may comprise a control unit, either to handle calculation of the position centrally (in case of one control unit) or in a distributed fashion (in case of multiple control units). In configurations with a wireless server, or a wired server 3 as in FIG. 1b, at least part of the calculation may be carried out by the server 3, and at least one of the tag or the anchors may be configured to pass on information to the server to allow calculation of distances and/or time differences and/or position at server side.

### Example 2

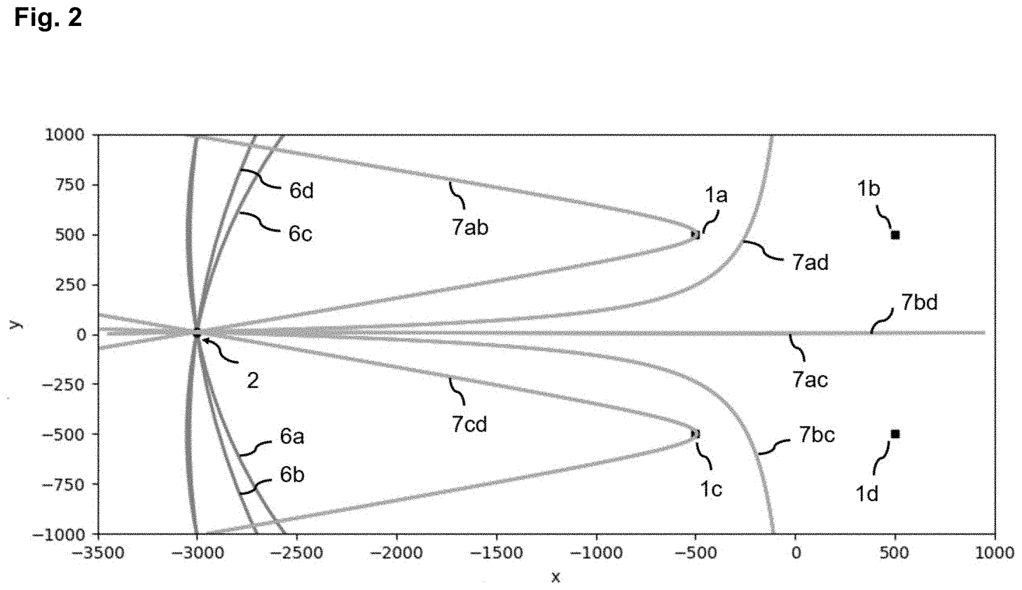

FIG. 2 illustrates an example configuration with four anchors 1a, 1b, 1c, 1d and a tag 2. In this example each of the anchors and the tag comprise wireless communication means being UWB communication means for transmitting and receiving packets to and from the other ones of said plurality of anchors and said tag. The configuration is shown in a 2D top view, with the first dimension (x) and second dimension (y) expressed in mm. While a 2D top view is shown, which is convenient for the purpose of graphical representation, the configuration may equally relate to a 2.5D or 3D configuration. The configuration relates to a square of four coplanar anchors 1a, 1b, 1c, 1d with coordinates (+/−500, +/−500), the side of the square being 1000 mm. The tag is positioned at a position (−3000, 0), which is outside of the rectangle and at a distance much larger than the side of the square.

In embodiments of the present invention, accurate positioning of the tag with respect to the anchors is possible by combining one or more of the TWR curves 6a, 6b, 6c, 6d, four in number, with one or more of the TDOA curves 7ab, 7ac, 7ad, 7bc, 7bd, 7cd, six in number.

The TWR curves 6a, 6b, 6c, 6d are obtained by, for each respective of the anchors 1a, 1b, 1c and 1d, controlling the tag 2 and the respective anchor to perform TWR, involving one or more first measurement packets and one or more second measurement packets. Based on the respective first and second measurement packets, a respective distance is calculated between the tag 2 and the respective anchor. For each respective anchor, a sphere (3D or 2.5D) or circle (2D) may be drawn for all potential tag locations that correspond with the respective distance. This results in respective TWR curves 6a, 6b, 6c, and 6d for anchor 1a, 1b, 1c, 1d.

With respect to prior art methods with positioning based solely on TWR, a position of the tag 2 may be determined at the intersection of the TWR curves. It should be noted, however, that the accuracy with respect to the x-coordinate of the tag 2 may be higher than the accuracy with respect to the y-coordinate. In this example, this relates to the tag 2 being distant from each of the anchors 1 according to the x-dimension. As can be seen on FIG. 1, a small deviation of the x-coordinate results in a large according deviation of the y-coordinate on each of the circle-shaped TWR curves, indicating that quality of estimation of the x-coordinate based solely on TWR is relatively high in this example. On the other hand, a small deviation of the y-coordinate only leads to a very small according deviation of the x-coordinate, indicating that quality of estimation of the y-coordinate based solely on TWR is relatively poor in this example.

The TDOA curves 7ab, 7ac, 7ad, 7bc, 7bd, 7cd are obtained by, for each respective pair of the anchors, calculating at least one time difference, based on at least one further measurement packet. This may, e.g., relate to transmitting at least one further measurement packet from the tag 2 to at least two of said plurality of anchors 1, in case of TDOA, but may alternatively or additionally relate to transmitting, to the tag 2, a respective first and second measurement packet, by a respective first and second one of said plurality of anchors 1. With four anchors 1a, 1b, 1c, 1d in this example, six respective pairs of anchors (1a, 1b), (1a, 1c), (1a, 1d), (1b, 1c), (1b, 1d), (1c, 1d) may be identified, corresponding, respectively, with TDOA curves 7ab, 7ac, 7ad, 7bc, 7bd, 7cd. For each given pair, the time difference is determined by considering a first time of flight between the first anchor of the pair and the tag, on the one hand, and a second time of flight between the second anchor of the pair and the tag. This time difference is derived from the at least one further measurement packet, which may, e.g., be a packet of TWR of the anchors of the anchor pair, a packet overheard by an anchor of the anchor pair from TWR of an anchor not belonging to the anchor pair, or an additional packet sent for the purpose of TDOA. For each respective pair of anchors, a hyperboloid (3D or 2.5D) or hyperbole (2D) may be drawn for all potential tag locations that correspond with the respective time difference. This results in respective TDOA curves 7ab, 7ac, 7ad, 7bc, 7bd, 7cd for anchor pairs (1a, 1b), (1a, 1c), (1a, 1d), (1b, 1c), (1b, 1d), (1c, 1d).

With respect to prior art methods with positioning based solely on TDOA, a position of the tag may be determined at the intersection of the TDOA curves. It should be noted, however, that, opposed to the case of TWR, the accuracy with respect to the y-coordinate of the tag 2 may be higher than the accuracy with respect to the x-coordinate. In this example, this relates to the tag 2 being distant from each of the anchors 1 according to the x-dimension. As can be seen on FIG. 1, a small deviation of the y-coordinate results in a large according deviation of the x-coordinate on each of the hyperbole-shaped TDOA curves, indicating that quality of estimation of the y-coordinate based solely on TDOA is relatively high in this example. On the other hand, a small deviation of the x-coordinate only leads to a very small according deviation of the y-coordinate, indicating that quality of estimation of the x-coordinate based solely on TDOA is poor in this example.

With positioning according to embodiments of the present invention, a position is calculated based on at least one distance and at least one time difference. Particularly, in this example, it may be sufficient to have a first measurement set with at least two of the TWR curves and one of the TDOA curves to determine the position at the intersection of the curves. Also, it may be sufficient to have a second measurement set with at least one of the TWR curves and at least two of the TDOA curves to determine the position at the intersection of the curves. For both the first and second measurement set, it may be expected, for the reasons indicated above, that the accuracy of positioning according to the present invention is higher than that of prior art methods based solely on TWR, on the one hand, or solely on TDOA, on the other hand. Thereby, a unique feature is the resilience to packet loss, causing, e.g., one or more distances to remain undetermined while an accurate position is still possible, owing to the combination of TWR and TDOA.

In embodiments, the position is determined taking into account noise/errors with respect to the determined distances and time differences. In this example, this may cause the intersection of the hyperbole-shaped TDOA curves to shift along the x-direction rather than along the y-direction (angle remains the same, distance changes). Also, this may cause the intersection of the circle-shaped TWR curves to shift along the y-direction rather than along the x-direction (angle changes, distance remains approximately the same).

Thereby it is to be noted that, as is known to the skilled person, the exact number of measurements needed depends on the specific configuration, and may be both lower or higher than in this example. For instance, in case of 1D-movement of the tag, e.g. in a running event, the actual number of measurements needed may be lower, whereas a geometry wherein anchors are aligned on a single straight line may result in more measurements being required.

In embodiments, one or more of the at least one further measurement packet, relating to TDOA or reverse TDOA, is transmitted while TWR is still ongoing. Or, in other words, at least one of said at least one further measurement packets is transmitted not later than at least one of said first and second measurement packets. This is advantageous since it saves time, having TDOA commence already while the packet exchange of TWR, preferably comprising a “handshake” or ACK, is taking place.

In embodiments, some or even all of the further measurement packets are packets of the TWR packet exchange. This provides the advantage of speed-up as well as improved accuracy and efficiency, reusing measurement packets used for TWR also for TDOA.

In embodiments of this example, the TWR and TDOA curves are determined by packet transmission and receipt wherein respective phases relating to TDOA and TWR are not entirely distinguishable or even indistinguishable. In embodiments, the positioning hence merely relates to transmitting and receiving packets between anchors and one or more tags until a sufficient number of one or more time differences and one or more distances is determined to allow positioning.

### Example 3

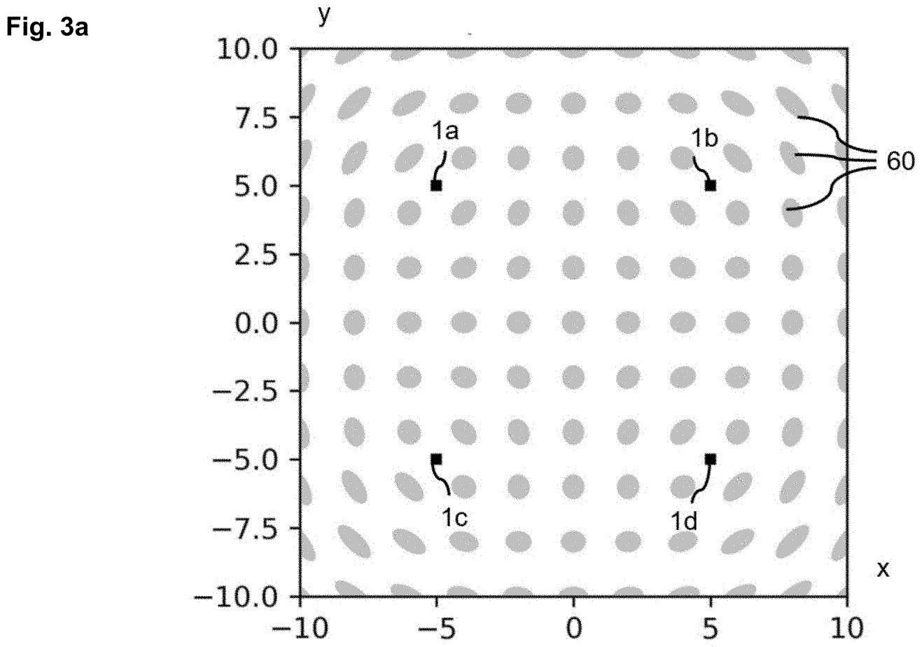

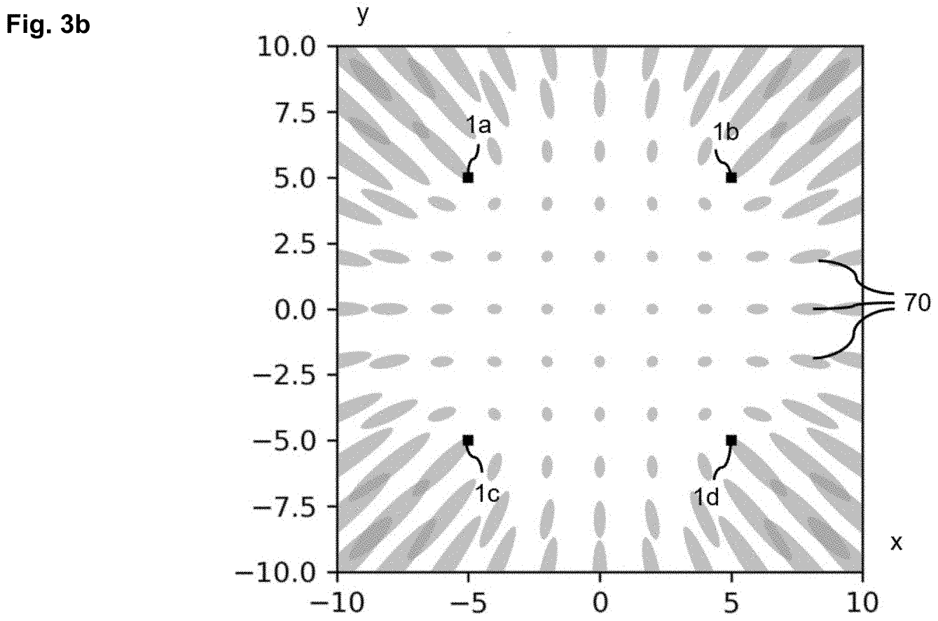

FIGS. 3a and 3b show example GDOP patterns relating to TWR and TDOA, respectively. It relates to an example configuration similar to that of Example 2, with four anchors 1a, 1b, 1c, 1d, with however no tag 2 displayed. It is assumed that each of the anchors and the tag comprise wireless communication means being UWB communication means for transmitting and receiving packets to and from the other ones of said plurality of anchors and said tag. The configuration is shown in a 2D top view, with the first dimension (x) and second dimension (y) expressed in m. The configuration relates to a square of four coplanar anchors 1a, 1b, 1c, 1d with coordinates (+/−5, +/−5), the side of the square being 10 m.

Assuming noise on UWB measurements is normally distributed around its theoretically expected value, the GDOP for both TWR, according to FIG. 3a, and TDOA, according to FIG. 3b, can be theoretically calculated. For both TWR and TDOA, respective confidence ellipses 60, 70 are drawn on a grid, in accordance with the calculated GDOP. For TWR, this is based on four range measurements (one with each anchor), each with four packets (two transmitted by the tag). These are reused by TDOA, having four times two blinks of the tag available, all received by all four anchors, i.e. each blink being received by the intended anchor but also overheard by the three other anchors. Inspecting FIGS. 3a and 3b, it is clear that the shape and size of confidence ellipses 60, 70 for TWR and TDOA differ. This shows the main improvements in accuracy that can be achieved by combining TWR and TDOA according to the invention. Furthermore, it is noted that most difference (but not all difference) occurs in the area outside the convex hull of the anchors 1a, 1b, 1c, 1d. With respect to the size of the confidence ellipses, it is noted that a larger number of blinks may reduce the size, while a smaller number of blinks may increase the size.

Referring to FIG. 3a, when the tag moves outside the convex hull of the anchors, TWR allows accurate distance estimation. This may be expressed in terms of a radial and a tangential direction, wherein the radial direction is the one extending outwardly from the origin (0,0), and the tangential direction is orthogonal to said radial direction. Accurate distance estimation is visible from the shape of the confidence ellipses 60 outside the convex hull, which extend mainly in the tangential direction, and to a much lesser degree in the radial direction. This indicates high accuracy with respect to distance of the tag from the center of the anchors, but large uncertainty on the angle estimation.

Referring to FIG. 3b, when the tag moves outside the convex hull of the anchors, TDOA allows accurate angle estimation. The distance estimation from the center of the anchors may be inaccurate, but the angle estimation is much more accurate compared to the TWR measurements.

This shows the main improvements in accuracy that can be achieved by combining TWR and TDOA according to the invention, as discussed for a similar configuration in Example 2.

In embodiments, the position is calculated taking into account deviations from the above theoretical results. Such deviations may relate to noise/errors in the UWB measurements following a general (non-normal) distribution, antenna delay, clock errors, synchronization errors. It is to be noted that such deviations impact TWR and TDOA differently. Therefore, the combination of TWR and TDOA according to the invention may improve robustness with respect to these deviations as well.

### Example 4

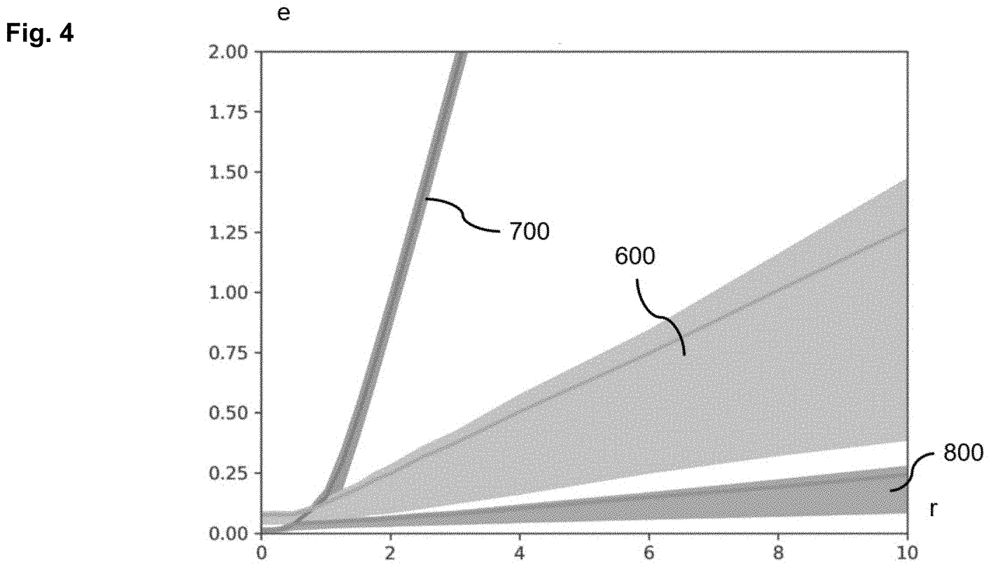

FIG. 4 shows position error e, expressed in mm, as a function of distance r from the center of the anchors, expressed in meter, for an example configuration, being a configuration of four coplanar anchors in a square, similar to Example 2 and Example 3, but now with side of the square equal to 0.6 m. For such a configuration, a tag at distance r is within the convex hull if r is smaller than 0.3 m; may or may not be within the convex hull if r is between 0.3 m and about 0.42 m (approximation of 0.3″sqrt(2)); and is outside the convex hull if r is larger than about 0.42 m. FIG. 4 shows error curves for TWR 600, TDOA 700, and the combination of TWR and TDOA 800 according to the invention. The curves are obtained with the same TWR ranging and number of blinks as in Example 3. For each curve, a spread reflects the difference in accuracy when considering different angles at same distance of the center. As can be expected, the TWR error curve 600 is always lower than the TDOA curve when the tag is sufficiently far removed from the convex hull of the tag.

Within the convex hull, the opposite holds true. The combination of TWR and TDOA, on the other hand, outperforms both TWR and TDOA especially outside of the convex hull, with much lower error values than any of TWR and TDOA whenever the distance is larger than, e.g., twice the side of the square.

Importantly, this example shows that combining TWR and TDOA does not lead to mere “inheriting” of the distance accuracy of TWR. Rather, the combination of TWR and TDOA according to the invention leads to overall better performance, including better distance accuracy than any of TWR or TDOA taken alone.

While embodiments are described in this document in relation to localization with anchors and one or more tags, the invention may be applied to any configuration with electronic devices wherein the position of one or more of the devices is tracked. Also, it is noted that embodiments are described wherein TWR and (reverse) TDOA have been presented as sequential, yet this need not be the case. In fact, the invention also encompasses embodiments wherein TDOA is the trigger for initial measurement packet transmission, and TWR is implemented by replying to these measurement packets with second measurement packets. The invention also encompasses embodiments wherein (reverse) TDOA and TWR are not formally distinguished, and the method of positioning merely relates to transmitting and receiving packets between anchors and one or more tags, either in a coordinated fashion or in a non-coordinated fashion, until a sufficient number of one or more time differences and one or more distances is determined to allow positioning.

1. A method for real-time locating system, RTLS, positioning of a tag (2) with respect to a plurality of anchors (1), said plurality preferably comprising at least three anchors (1), wherein each of the anchors (1) and the tag (2) comprise wireless communication means (11) for transmitting and receiving packets to and from the other ones of said plurality of anchors (1) and said tag (2), preferably ultra-wide band, UWB, communication means;
said method comprising the steps of:
for each respective of the anchors (1), controlling the tag (2) and the respective anchor
(1) to perform two-way ranging, TWR, said TWR comprising at least the substeps of controlling one of the tag (2) and the respective anchor (1) to transmit one or more first measurement packets (101) to the other one of the tag and the respective anchor, and
controlling the other one of the tag and the respective anchor to, upon receipt of each respective of the first measurement packets (101), transmit a respective second measurement packet (102) to the one of the tag and the respective anchor that transmitted the respective first measurement packet (101);
calculating, by said tag (2) or by any of said plurality of anchors (1) or by a server (3) connected to said plurality of anchors (1), the position of said tag (2), said calculating comprising at least the substeps of:
for each respective of the anchors (1), calculating a respective distance with respect to said tag (2) based on at least one of the one or more first measurement packets (101) and at least one of the one or more second measurement packets (102) obtained for the respective anchor (1);
calculating at least one time difference based on at least one further measurement packet,
wherein, when said at least one time difference relates to time difference of arrival, TDOA, said at least one further measurement packets is transmitted between the tag (2) and at least two of said plurality of anchors (1), and/or
wherein, when said at least one time difference relates to reverse TDOA, said at least one further measurement packet comprises at least a respective first and second further measurement packet transmitted between the tag (2) and respective ones of said plurality of anchors (1); and
calculating, based on said respective distances and said at least one time difference, the position of said tag (2);
wherein at least one of said at least one further measurement packet is transmitted not later than at least one of said first and second measurement packets (101, 102).

2. Method of claim 1, wherein said at least one of said at least one further measurement packet being transmitted not later than at least one of said first and second measurement packets (101, 102) relates to said at least one of the at least one further measurement packet being one of the first or second measurement packets (101, 102).

3. Method of claim 2, wherein said at least one of the at least one further measurement packet being one of the first or second measurement packets (101, 102) relates to
a further anchor of said plurality of anchors (1) overhearing said one of the first or second measurement packets (101, 102) belonging to the TWR of the tag (2) and an anchor different from said further anchor; and/or
a further tag different from said tag (2) overhearing said one of the first or second measurement packets (101, 102) belonging to the TWR between the tag (2) and one of the anchors (1).

4. Method of claim 2, wherein all of the at least one further measurement packet are first or second measurement packets (101, 102).

5. Method of claim 1, wherein the method comprises the further step of:
controlling at least one of the plurality of anchors (1) and the tag (2) to transmit one or more third measurement packets different from said first and second measurement packets (101, 102);
wherein at least one of the at least one further measurement packet is one of the third measurement packets.

6. Method of claim 1, wherein said calculating of said position is performed at least in part by said tag (2), preferably is performed entirely by said tag (2), and wherein said at least one time difference relates to reverse TDOA.

7. Method of claim 1, wherein said calculating of said position is performed at least in part by any of said plurality of anchors (1) or by said server (3), preferably is performed entirely by said server (3), and wherein said at least one time difference relates to TDOA.

8. Method of claim 1, wherein the method comprising the further step of:
calculating, by at least one of the anchors (1), said tag (2) or the server (3) connected to said plurality of anchors (2), a clock rate and/or a clock offset of at least one of the anchors or the tag;
wherein said calculating of said clock rate and/or said clock offset is based at least in part on one or more of the one or more first or second measurement packets (101, 102) or the at least one further measurement packet, preferably is based at least in part on one or more of the one or more first or second or third measurement packets (101, 102) or the at least one further measurement packet.

9. Method of claim 1, wherein the tag (2) belongs to a plurality of tags comprising at least one further tag, said further tag comprising said wireless communication means (11) for transmitting and receiving packets to and from the plurality of anchors (1) and said tag (2); wherein a relative position among the plurality of anchors (1) is fixed; wherein a relative position between the plurality of tags is fixed; and wherein said calculating of said position of said tag (2) comprises calculating a single tag group position associated with the plurality of tags.

10. Method of claim 9, wherein the method comprises the further step of:
calculating, by any of said tag (2) or said further tag or by any of the plurality of anchors (1) or by the server (3) connected to said plurality of anchors (2), a tag group orientation associated with the plurality of tags (2).

11. Method of claim 1, wherein the plurality of anchors (1) and the tag (2), preferably the plurality of anchors (1) and the plurality of tags (1), are configured as interchangeable devices, wherein the method comprises the further step of:
calculating a second position associated with one of the anchors (1) acting according to a tag configuration; and/or
calculating said position or said second position based at least in part on said tag (2) acting according to an anchor configuration.

12. Method of claim 1, wherein the method comprises the further steps of:
calculating a confidence value with respect to said calculated position being a non-final position;
comparing said confidence value with a predetermined value;
if said confidence value is below a predetermined value:
controlling at least one of the plurality of anchors (1) and the tag (2) to transmit a fourth measurement packet different from said first and second measurement packets (101, 102);
calculating one or more second time differences relating to said TDOA and/or said reverse TDOA, based on at least said fourth measurement packet; and
recalculating the position based on said one or more second time differences;
assigning said recalculated position as a final position; else,
assigning the non-final position as the final position.

13. Method of claim 1, wherein said performing of said TWR relates to any or any combination of: symmetric double-sided ranging, asymmetric double-sided ranging, fast ranging, mass ranging.

14. A system comprising
a plurality of anchors (1), said plurality preferably comprising at least three anchors;
a tag (2);
preferably, a server (3) connected to said plurality of anchors (1);
wherein each of said anchors (1) and said tag (2) comprise wireless communication means (11) for transmitting and receiving packets to and from the other ones of said plurality of anchors (1) and said tag (2);
wherein each of said anchors (1) and said tag (2) are configured for performing two-way ranging, TWR, said TWR comprising, for each respective of the anchors (1), at least the substeps of
controlling one of the tag (2) and the respective anchor (1) to transmit one or more first measurement packets (101) to the other one of the tag and the respective anchor, and
controlling the other one of the tag and the respective anchor to, upon receipt of each respective of the first measurement packets (101), transmit a respective second measurement packet (102) to the one of the tag and the respective anchor that transmitted the respective first measurement packet (101);
wherein any of said tag (2) or any of said plurality of anchors (1) or said server (3) is further configured for calculating a position of said tag (2), said calculating comprising at least the substeps of:
for each respective of the anchors (1), calculating a respective distance with respect to said tag (2) based on at least one of the one or more first measurement packets (101) and at least one of the one or more second measurement packets (102) obtained for the respective anchor (1);
calculating at least one time difference based on at least one further measurement packet,
wherein, when said time difference relates to time difference of arrival, TDOA, said at least one further measurement packet is transmitted between the tag (2) and at least two of said plurality of anchors (1), and/or
wherein, when said at least one time difference relates to reverse TDOA, said at least one further measurement packet comprises at least a respective first and second further measurement packet transmitted between the tag and respective ones of said plurality of anchors; and
calculating, based on said respective distances and said at least one time difference, the position of said tag (2);
wherein at least one of said at least one further measurement packet is transmitted not later than at least one of said first and second measurement packets (101, 102).

15. A non-transient storage device, comprising computer-executable instructions which, when executed on a processor, cause the processor to perform the method of claim 1.
